(19) United States
(12) Patent Application Publication
(10) Pub. No.: US 2003/0079501 A1
(43) Pub. Date: May 1, 2003

(54) Method of drawing multi-line optical fiber

(76) Inventor: Yeong-Seop Lee, Kumi-shi (KR)

Correspondence Address: Robert E. Bushnell, Suite 300, 1522 K Street, N.W., Washington, DC, 20005, US

(21) Appl. No.: 10/315,116

(22) Filed: Dec. 10, 2002

Related U.S. Application Data
(62) Division of application No. 09/639,332, filed on Aug. 16, 2000.

(30) Foreign Application Priority Data
Aug. 25, 1999 (KR) 1999/35455

(51) Int. Cl. C03B 37/07

(52) U.S. Cl. 65/382; 65/435

(57) ABSTRACT

Disclosed is a multi-line optical fiber drawing equipment, wherein at least two strands of optical fibers can be simultaneously drawn by the single draw tower, thereby maximizing an effectiveness of an installation space for a draw tower and the productivity in drawing the optical fiber. The optical fiber multi-line drawing equipment has at least two lines for drawing optical fibers from preforms. Each of the lines has a chuck, a furnace, a cooling unit, a coating unit, a curing unit, and a capstan, which are arranged in sequence in a draw tower. Processes for drawing optical fibers from preforms respectively along the lines are simultaneously performed.

### CLAIM OF PRIORITY

This application makes reference to, incorporates the same herein, and claims all benefits accruing under 35 U.S.C. §119 from an application for OPTICAL FIBER MULTI-LINE DRAWING EQUIPMENT earlier filed in the Korean Industrial Property Office on the 25^{th} of August 1999 and there duly assigned Serial No. 35455/1999.

### BACKGROUND OF THE INVENTION

1. Field of the Invention

The present invention relates to an optical fiber manufacturing system, and more particularly to an optical fiber multi-line drawing equipment, in which at least two lines of drawing optical fibers from preforms are installed in a single draw tower, so that at least two strands of optical fibers are simultaneously drawn by the single draw tower.

2. Description of the Related Art

In general, a process for manufacturing a strand of optical fiber includes the steps of manufacturing a preform of the optical fiber and drawing the optical fiber from the preform. An optical fiber drawing equipment is used in order to draw a strand of optical fiber from the preform. The optical fiber drawing equipment has several processing devices arranged vertically in a draw tower according to the processing order. The drawing process is sequentially performed according to the arranged order of the processing devices of the drawing equipment.

In a conventional optical fiber drawing apparatus used in optical fiber drawing, a preform of an optical fiber fixed by a chuck is melted by heat of sufficiently high temperature of at least 2000° C. in a furnace, moved up and down by a feeding unit, and then is drawn out to be an optical fiber. The drawn optical fiber is controlled to have a proper diameter by a diameter controller, and then is carried through a cooling unit to be cooled to a desired temperature before being coated. The cooled optical fiber is coated while passing through a coater, and then an ultraviolet ray-curable polymer (UV-curable polymer) coated on the optical fiber is cured while the optical fiber passes through a plurality of UV curing units. In this case, the coating material is coated around the optical fiber by means of its viscosity and surface tension. After passing the curing units, the optical fiber passes through a capstan and a plurality of rollers, and then is wound around a winder. The capstan applies a predetermined tension to the preform, so that a strand of optical fiber having a desired diameter can be drawn out.

The furnace, the diameter controller, the cooling unit, the coater, the curing units, and the capstan are arranged vertically in sequence in the stand-type draw tower, so that a series of the steps of the optical fiber drawing process are sequentially performed.

The conventional optical fiber drawing equipment employs a process, in which a preform is leveled by a chuck, and then a strand of optical fiber is drawn out from the preform through various steps by various processing devices.

However, the conventional optical fiber drawing equipment is problematic in that it has a low productivity, since only one strand of optical fiber is drawn through a plurality of steps by the processing devices arranged in the draw tower, which are expensive. In other words, in the conventional optical fiber drawing equipment, three separate draw towers are necessary and three separate preforms should be prepared, in order to draw three strands of optical fibers.

Examples of the conventional art in which more than one fiber is drawn simultaneously are seen in the following U.S. Patents. U.S. Pat. No. 4,373,943, to Gouronnec et al., entitled MULTIPLE FIBER FORMING MACHINE, describes a machine having an assembly for drawing a plurality of fibers and linear multi-fiber stranding assembly.

U.S. Pat. No. 4,204,852, to Watts et al., entitled METHOD OF AND APPARATUS FOR PRODUCING A GLASS FIBRE BUNDLE FOR USE IN OPTICAL COMMUNICATIONS, describes an apparatus including a furnace, a retaining member for holding glass rods, and means for drawing the rods into fibers and forming the drawn fibers into a fiber bundle.

### SUMMARY OF THE INVENTION

It is therefore an object of the present invention to provide an improved apparatus and method for drawing optical fibers.

A further object of the present invention to provide an optical fiber drawing apparatus which is more efficient in use of space.

A yet further object of the present invention to provide an optical fiber drawing apparatus which increases the productivity of optical fiber.

A still further object of the present invention is to provide an optical fiber drawing apparatus which is more cost-effective.

Accordingly, the present invention has been made in an effort to solve the problems occurring in the related art, and it is an object of the present invention to provide a multi-line optical fiber drawing equipment, in which at least two lines of drawing optical fibers from preforms are installed in a draw tower, so that at least two strands of optical fibers are simultaneously drawn by the single draw tower.

In accordance with one aspect of the present invention, there is provided a multi-line optical fiber drawing equipment comprising at least two lines for drawing optical fibers from preforms, each of the lines including a chuck, a furnace, a cooling unit, a coating unit, a curing unit, and a capstan, which are arranged in sequence in a draw tower, wherein processes for drawing optical fibers from preforms respectively along the lines are simultaneously performed.

Preferably, the furnace, the cooling unit, the coating unit, and the curing unit may respectively be an integrated type, in which separate preforms are heated, cooled, coated, and cured to be drawn out into one strand of optical fiber. Otherwise, the cooling unit, the coating unit, and the curing unit may respectively be a separated type, in which separate preforms are heated, cooled, coated, and cured to be drawn out into separate strands of optical fibers.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic side elevation of a conventional optical fiber drawing apparatus, showing the construction thereof;

FIG. 2 is a schematic side elevation of a multi-line optical fiber drawing apparatus according to an embodiment of the present invention, showing the construction thereof; and

FIG. 3 is a schematic side elevation of a multi-line optical fiber drawing apparatus according to another embodiment of the present invention, showing the construction thereof.

### DETAILED DESCRIPTION OF THE INVENTION

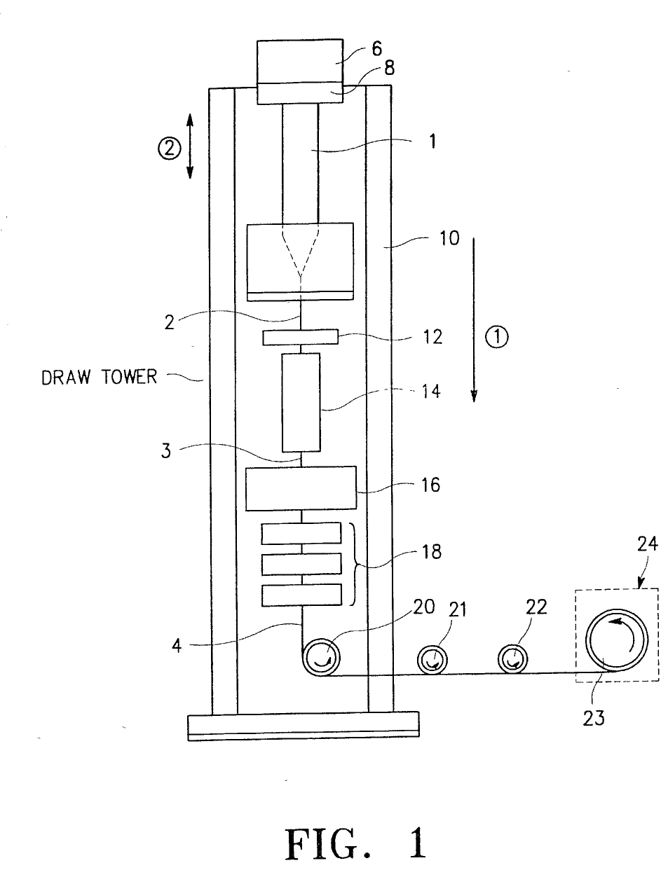

Turning now to the drawings, FIG. 1 shows the conventional optical fiber drawing apparatus used in optical fiber drawing as discussed above. As shown in FIG. 1, a preform 1 of an optical fiber fixed by a chuck 8 is melted by heat of sufficiently high temperature of at least 2000° C. in a furnace 10, moved up and down as indicated by the arrow of the circled reference numeral \mathring{2} by a feeding unit 6, and then is drawn out to be an optical fiber 2. The drawn optical fiber 2 is controlled to have a proper diameter by a diameter controller 12, and then is carried through a cooling unit 14 to be cooled to a desired temperature before being coated. The cooled optical fiber 3 is coated while passing through a coater 16, and then an ultraviolet ray-curable polymer (UV curable polymer) coated on the optical fiber is cured while the optical fiber passes through a plurality of UV curing units 18. In this case, the coating material is coated around the optical fiber by means of its viscosity and surface tension. After passing the curing units 18, the optical fiber 4 passes through a capstan 20 and a plurality of rollers 21 and 22, and then is wound around a winder 24. The capstan 20 applies a predetermined tension to the preform 1, so that a strand of optical fiber having a desired diameter can be drawn out. Reference numeral 23 not described above designates a take-up reel or a spool around which the optical fiber is wound. Further, the arrow referenced by the circled numeral \mathring{1} indicates the progressing direction of the optical fiber drawing process.

The furnace 10, the diameter controller 12, the cooling unit 14, the coater 16, the curing units 18, and the capstan 20 are arranged vertically in sequence in the stand-type draw tower, so that a series of the steps of the optical fiber drawing process are sequentially performed.

The characteristics and advantages of the present invention will now become apparent from the following description about embodiments of the invention, with reference to the accompanying drawings. In the following description, a detailed description about the construction and the function in relation to the known related will be avoided, so as not to obscure the gist of the invention.

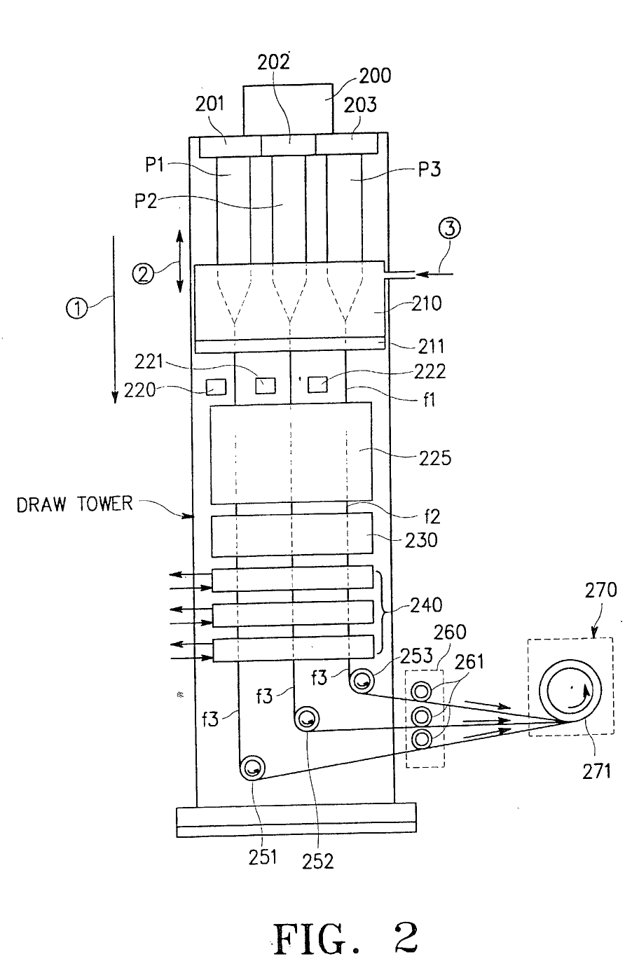

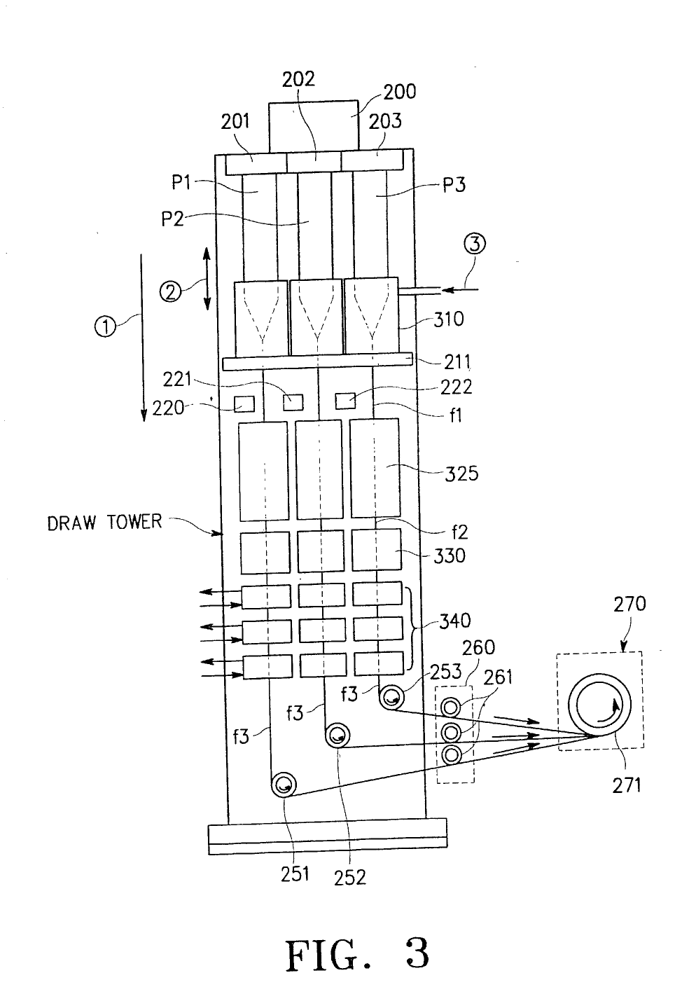

FIGS. 2 and 3 are schematic side elevations of optical fiber multi-line drawing apparatuses according to embodiments of the present invention, showing the constructions thereof. Referring to FIGS. 2 and 3, a multi-line optical fiber drawing apparatus according to an embodiment of the present invention includes at least two lines of drawing optical fibers from a preform in a draw tower. In each of the lines of drawing optical fibers from a preform, one strand of optical fiber is drawn from one preform by a series of processing devices arranged according to the order of the processing steps in a draw tower.

Referring to FIG. 2, each optical fiber drawing line includes optical fiber preforms P1, P2 and P3 leveled or held in proper orientation by chucks 201, 202 and 203, a furnace 210, optical fiber diameter controllers 220, 221 and 222, a cooling unit 225, a coating unit 230, a plurality of ultraviolet ray curing units 240, capstans 251, 252 or 253, and optical fiber winding means 270.

The furnace 210 installed in the draw tower may be an integrated type as shown in FIG. 2, in which separate preforms P1, P2, and P3 are heated to be drawn out as one strand of optical fiber. Alternatively, furnaces 310 of a separated type may be installed in the draw tower as shown in FIG. 3, in which each preform P1, P2, or P3 respectively has a separate furnace 310, and the furnaces 310 are carried by a single carrier 211. Further, instead of the integrated-type cooling unit 225, the coating unit 230, and the curing units 240 of FIG. 2, separated-type cooling units 325, coating units 330 and curing units 340 may alternatively be used, respectively. FIG. 3 illustrates an embodiment using separate furnaces 310, cooling units 325, coating units 330 and curing units 340.

FIG. 2 shows an example of a multi-line optical fiber drawing equipment in which three drawing lines of optical fibers are contained in a draw tower. However, the scope of the present invention is not restricted by the draw tower containing the three optical fiber drawing lines, but the present invention may employ two lines or four or more lines of drawing optical fibers from preforms according to other embodiments thereof.

Hereinafter, the optical fiber drawing lines, wherein three preforms P1, P2, and P3 are adapted to one draw tower, will be explained, with reference to FIG. 2. First, second, and third preforms P1, P2, and P3 of optical fibers are respectively leveled in the vertical direction by first, second, and third chucks 201, 202, and 203, and then are repeatedly moved up and down in the vertical direction by a feeding unit 200 as indicated by the arrow having the circled reference numeral \mathring{2}. The first, the second, and third preforms P1, P2, and P3 are melted by the heat of a sufficiently high temperature of at least 2000° C. in the furnace 210 while they undergo the above vertical alternating, and then are drawn out into optical fibers. In this case, inert gas is injected in the direction indicated by the arrow having the circled reference numeral \mathring{3} into the furnace 210, so as to generate a uniform hot zone in a longitudinal direction of the optical fibers, thereby drawing the optical fibers.

The diameters of the drawn optical fibers f1 are respectively controlled by the diameter controllers 220, 221, and 222, and then the drawn optical fibers f1 are cooled to a proper temperature by the cooling unit 230. The cooled optical fibers f2 are coated with curable polymer while passing through the coating unit 230, and the coated curable polymer is cured while passing through a plurality of the curing units 240. The curable polymer is coated on the uniformly cooled optical fibers by means of its viscosity and surface tension when the cooled optical fibers f2 pass through the curable polymer. The curing units 240 project ultraviolet rays on the coated optical fibers passing through the curing units 240 by means of ultraviolet lamps (not shown). At the same time, nitrogen gas is injected into a quartz tube (not shown) in the curing units 240 while a suctioning operation is performed, so as to maintain an atmosphere without oxygen in the quartz tube, thereby achieving a uniform curing process.

The cured optical fibers f3 pass through the capstan rollers 251, 252, and 253, so that the tension of the optical fibers is adjusted. At last, the optical fibers are wound around the winding means 270. Reference numeral 260 is a guide portion. The reference numeral 261 designates guide rollers, and the reference numeral 271 designates a take-up reel or a spool. The arrow of the circled reference numeral \mathring{1} indicates a direction in which the optical fiber drawing process progresses. That is, an optical fiber preform is processed in sequence in the direction of the arrow \mathring{1} to be drawn out into a strand of optical fiber. Operation of the embodiment shown in FIG. 3, having separated-type furnaces, cooling units, coating units and curing units, is analogous to that of the embodiment shown in FIG. 2.

According to the present invention, in the case where three preforms are fed to be drawn out into three strands of optical fibers through three optical fiber drawing lines, the productivity is increased three times in comparison with the prior art. Further, the effectiveness in utilizing the installation space for the draw tower can be maximized, since the processing devices to be installed in three draw towers can be contained in a single draw tower.

As described above, the present invention maximizes the effectiveness in utilizing the installation space for the draw tower and highly increases the productivity of the optical fiber drawing equipment, by employing multiple optical fiber drawing lines in an area for a single draw tower.

While there have been illustrated and described what are considered to be preferred specific embodiments of the present invention, it will be understood by those skilled in the art that the present invention is not limited to the specific embodiments thereof, and various changes and modifications and equivalents may be substituted for elements thereof without departing from the true scope of the present invention.

What is claimed is:

1. An optical fiber drawing apparatus, comprising:
a first chuck for holding a first optical fiber preform;
a second chuck located adjacent to said first chuck, for holding a second optical fiber preform;
a furnace located below said first chuck and second chuck, for heating the first and second optical fiber preforms;
a carrier connected to said furnace;
a first optical fiber diameter controller located below the furnace; for controlling the diameter of a fiber drawn from the first optical fiber preform;
a second optical fiber diameter controller located below the furnace, for controlling the diameter of a fiber drawn from the second optical fiber preform;
a cooling unit located below the first optical fiber diameter controller, for cooling an optical fiber drawn from the first optical fiber preform;
a coating unit located below the cooling unit, for coating an optical fiber drawn from the first optical fiber preform;
an ultraviolet curing unit located below the coating unit, for curing a coated optical fiber;
a first capstan, for adjusting the tension of a fiber produced from the first optical fiber preform;
a second capstan, for adjusting the tension of a fiber produced from the second optical fiber preform; and
an optical fiber winding means for winding fibers produced from the first and second optical fiber preforms.

2. The optical fiber drawing apparatus of claim 1, further comprising:
a third chuck for holding a third optical fiber preform;
a third optical fiber diameter controller; and
a third capstan, for adjusting the tension of a fiber produced from the third optical fiber preform;
said furnace further being for heating the third optical fiber preform; and
said winding means further being for winding fiber produced from the third optical fiber preform.

3. The optical fiber drawing apparatus of claim 1, said cooling unit further being for cooling the optical fiber drawn from the second optical fiber preform.

4. The optical fiber drawing apparatus of claim 2, said cooling unit further being for cooling the optical fibers drawn from the second and third optical fiber preforms.

5. The optical fiber drawing apparatus of claim 1, said coating unit further being for coating the optical fiber drawn from the second optical fiber preform.

6. The optical fiber drawing apparatus of claim 2, said coating unit further being for coating the optical fibers drawn from the second and third optical fiber preforms.

7.The optical fiber drawing apparatus of claim 1, said ultraviolet curing unit further being for curing the optical fiber drawn from the second optical fiber preform.

8. The optical fiber drawing apparatus of claim 2, said ultraviolet curing unit further being for curing the optical fibers drawn from the second and third optical fiber preforms.

9.The optical fiber drawing apparatus of claim 5, said ultraviolet curing unit further being for curing the optical fiber drawn from the second optical fiber preform.

10. The optical fiber drawing apparatus of claim 6, said ultraviolet curing unit further being for curing the optical fibers drawn from the second and third optical fiber preforms.

11. The optical fiber drawing apparatus of claim 1, said optical fiber winding means further comprising:
a first guide roller for guiding an optical fiber from the first capstan;
a second guide roller for guiding an optical fiber from the second capstan; and
a take-up reel for taking up the optical fibers from the first and second capstan.

12. The optical fiber drawing apparatus of claim 1, said ultraviolet curing unit further comprising:
a quartz tube; and
a nitrogen gas injector for excluding oxygen in the quartz tube during curing.

13. An optical fiber drawing apparatus, comprising:
a first chuck for holding a first optical fiber preform;
a second chuck located adjacent to said first chuck, for holding a second optical fiber preform;
a first furnace located below said first chuck, for heating the first optical fiber preform;
a second furnace located below said second chuck, for heating the second optical fiber preform;
a carrier connected to said first and second furnaces;
a first optical fiber diameter controller located below said first furnace; for controlling the diameter of a fiber drawn from the first optical fiber preform;
a second optical fiber diameter controller located below said second furnace, for controlling the diameter of a fiber drawn from the second optical fiber preform;
a first cooling unit located below the first optical fiber diameter controller, for cooling an optical fiber drawn from the first optical fiber preform;
a first coating unit located below the first cooling unit, for coating an optical fiber drawn from the first optical fiber preform;
a first ultraviolet curing unit located below the first coating unit, for curing a coated optical fiber;
a first capstan, for adjusting the tension of a fiber produced from the first optical fiber preform;
a second capstan, for adjusting the tension of a fiber produced from the second optical fiber preform; and
an optical fiber winding means for winding fibers produced from the first and second optical fiber preforms.

14. The optical fiber drawing apparatus of claim 13, further comprising:
a third chuck for holding a third optical fiber preform;
a third furnace connected to said carrier, for heating the third optical fiber preform;
a third optical fiber diameter controller;
a third capstan, for adjusting the tension of a fiber produced from the third optical fiber preform; and
said winding means further being for winding fiber produced from the third optical fiber preform.

15. The optical fiber drawing apparatus of claim 13, further comprising:
a second cooling unit located below the second optical fiber diameter controller, for cooling an optical fiber drawn from the second optical fiber preform.

16. The optical fiber drawing apparatus of claim 13, further comprising:
a second ultraviolet curing unit located below the second cooling unit, for cooling an optical fiber drawn from the second optical fiber preform.

17. The optical fiber drawing apparatus of claim 13, further comprising:
a second coating unit located below the second optical fiber diameter controller, for coating an optical fiber drawn from the second optical fiber preform.

18. The optical fiber drawing apparatus of claim 14, further comprising:
a second cooling unit and a third cooling unit, for cooling optical fibers drawn from the second and third optical fiber preforms;
a second ultraviolet curing unit and a third ultraviolet curing unit, for cooling optical fibers drawn from the second and third optical fiber preforms; and
a second coating unit and a third coating unit, for coating optical fibers drawn from the second and third optical fiber preforms.

19. The optical fiber drawing apparatus of claim 13, said optical fiber winding means further comprising:
a first guide roller for guiding an optical fiber from the first capstan;
a second guide roller for guiding an optical fiber from the second capstan; and
a take-up reel for taking up the optical fibers from the first and second capstan.

20. The optical fiber drawing apparatus of claim 13, said ultraviolet curing unit further comprising:
a quartz tube; and
a nitrogen gas injector for excluding oxygen in the quartz tube during curing.

21. The optical fiber drawing apparatus of claim 1, said furnace further comprising:
an inert gas injector for generating a longitudinally uniform hot zone.

22. The optical fiber drawing apparatus of claim 13, said first and second furnaces each further comprising:
an inert gas injector for generating a longitudinally uniform hot zone.
